(19) United States
(12) Patent Application Publication
(10) Pub. No.: US 2010/0310297 A1
(43) Pub. Date: Dec. 9, 2010

(54) PACKAGING DEVICE

(75) Inventor: Jean-Louis Gueret, Paris (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/739,542

(22) PCT Filed: Dec. 18, 2008
(86) PCT No.: PCT/IB2008/055415

§ 371 Date: Jun. 2, 2010

Related U.S. Application Data
(60) Provisional application No. 61/018,528, filed on Jan. 2, 2008.

(30) Foreign Application Priority Data
Dec. 19, 2007 (FR) 0760045

(51) Int. Cl. A45D 34/00; A45D 40/00; B05D 3/00; C25D 5/02

(52) U.S. Cl. 401/129; 222/236; 220/544; 427/294; 205/131

(57) ABSTRACT

The present invention provides a device for packaging a composition for applying to keratinous materials, the device comprising a container defining an inside space containing the composition; a coating of a biocidal material covering at least part of the container and coming into contact with the composition contained in the inside space of the container; and a member that is movable within the container.

The present invention relates to devices for packaging a composition for application to keratinous materials, and more particularly but not exclusively it relates to devices fitted with an applicator or with dispenser means, e.g. a pump.

The term “keratinous materials” should be understood below as designating in particular the skin, the mucous membranes, including the lips, the nails, hair, the eyelashes, and the eyebrows.

Publication EP 1 314 373 A2 discloses devices in which particles capable of containing silver are immersed in a container containing a cosmetic composition.

JP 2000 109076 discloses a bottle internally coated in SiOₓ in order to constitute a barrier to oxygen.

There exists a need to reduce the preservative content of various compositions, in particular cosmetics, and/or to improve the conservation of such compositions.

There also exists a need to release at least one compound progressively into a composition while the composition is in use and/or in storage in the packaging device.

The invention seeks to satisfy one and/or the other of these needs.

The invention achieves this by means of a device for packaging a composition for application to keratinous materials, the device comprising:
a container defining an inside space containing the composition, the container being made for example out of one or more thermoplastic materials; and
a coating of a biocidal material covering at least part of the container and coming into contact with the composition contained in the inside space of the container.

The device for packing may include a member which is movable within the container.

The movable member may come near the coating or even in contact with the coating, the distance between the movable member and the coating being for example in the range 0 to 3 mm, i.e. in the range 0 to 1 mm, or even in the range 0 to 0.5 mm, better in the range 0 to 0.2 mm, for example of about 0.1 mm.

The movable member may constitute part of the container or may be associated to a part constitutive of the container. This movable member may for example be integral with the bottom of the container.

The movable member may be capable of stirring the composition along a lateral inside wall of the container in a manner so as to force the composition to flow along this inside wall on which the coating is disposed. After having flowed along the lateral inner wall of the container, the composition may for example be directed by the movable member towards an applicator, i.e. around or through the applicator.

The movable member for example in the form of a blade may conform to at least a part of the lateral inner wall of the container.

The movable member may for example be made by at least a first blade which cooperates with at least a second blade mobile in relation to the first blade, to define two chambers inside the container and at least a passage between both chambers disposed between the first and second blades. The applicator is for example disposed at least in part in this passage, a movement of the first blade in relation to the second blade causing volume variations of the chambers and causing emptying of one of the chambers towards the other chamber through the passage. The passage may be for example made by an interstice between the first blade and the second blade, this interstice being opened from the bottom to the top of the blades or on part of the height of the blades partially joined.

The device may comprise a movable member inside the container which comes advantageously in contact with the coating and may rub on the coating. This may improve the effect of the coating.

The term “biocidal material” should be understood as designating a material having properties that oppose the proliferation of microorganisms in the composition.

The coating may release at least one compound while the composition is in use and/or in storage, e.g. because the coating is in contact with the composition.

It is possible to use various coatings of different kinds, providing they have biocidal properties, either individually or in association.

Advantageously, the device includes means enabling the composition to be caused to move in contact with the coating, such stirring being capable of encouraging the compound to pass into solution and/or become dispersed within the composition.

The coating may be deposited by a vacuum deposition technique or by an electrolytic deposition technique.

The coating may comprise a layer in contact with the composition and one or more under-layers serving as a keying primary layer on a wall of the container, for example a metal under-layer, e.g. of: chromium VI; nickel; copper; silver; tungsten; and alloys thereof; or of other metals and alloys.

The presence of an under-layer serving as a keying primary layer can be particularly useful when the container is made of thermoplastic material. When the container is made of glass or of metal, it is possible to deposit the coating without a primary layer.

The container may comprise at least a first portion and a second portion, these portions being assembled together. The first and second portions may optionally be in contact with each other.

By making the container out of at least two portions, it is easier to deposit the coating, in particular by a vacuum evaporation technique or by a cathode sputtering technique, with the coating being deposited on at least one of the portions.

The above-described first and second portions may together define the maximum capacity of the container.

Each of the first and second portions may define both an inside surface and an outside surface of the container.

The first and second portions may be stationary relative to each other or they may be movable relative to each other. In particular, these two portions may be suitable for being driven to move relative to each other from outside the device so as to move in controlled manner.

The second portion may be movable relative to the first, e.g. in turning or in translation, and this movement may contribute to moving the composition relative to the coating. Moving the second portion relative to the first may optionally be accompanied by a reduction in the working volume of the container.

The first and second portions may bear against each other in leaktight manner.

The material constituting the coating may optionally be suitable for dispersing under the effect of the second portion moving relative to the first portion or under the effect of the composition moving within the container and/or under the effect of a movable part moving within the container.

The container may include a wall coated in the coating with the ratio of the wall thickness divided by the coating thickness being, for example, greater than or equal to 100. For example, the container may have a wall with a thickness of more than 1 millimeter (mm) made of a thermoplastic material, and the coating may present a thickness of less than 20 micrometers (μm) or less than 10 μm, for example being 1 μm or 2 μm thick.

The coating may comprise at least one metal compound, which may include silver or copper. In some examples, the coating includes an under-layer of a material that is different from the layer that is exposed to the composition, e.g. an under-layer of tungsten. By way of example, the coating may comprise a stack of layers of copper, of tungsten, and of silver, or of tungsten and of silver.

The coating may extend over both the first and the second portions, or it may extend over only one of them.

The first portion may be covered in a first coating and the second portion may be covered in a second coating of a material different from the first. By way of example, one of the portions may have a coating of silver and the other a coating of copper.

The inside space of the container may present a ratio of its greatest transverse dimension divided by its height lying in the range 0.5 to 3, better in the range 0.75 to 1.5, or 0.85 to 1.15. The inside space may be deeper than it is wide, or it may be as deep as it is wide in various embodiments of the invention.

The device may include an applicator. When the applicator is arranged to be inserted into the container or to be withdrawn therefrom, it may optionally cause the composition to move inside the container.

The applicator may be optionally distinct from the movable stirring member. An applicator is for example made distinct from the movable stirring member in the sense of the movable stirring member is made by a piece distinct and separated from the piece of which the applicator is made.

The first portion may define at least one thrust surface in contact with the composition inside the container, said thrust surface being arranged in such a manner that turning said surface exerts pressure on the composition, causing the composition to move inside the container, the second portion defining at least one backing surface against which the thrust surface can come at least partially opposite to the end of said first portion being turned. Where appropriate, the thrust surface may be moved in a pure rotary movement without any axial component.

The applicator may include an applicator element received inside the container, in a space around which said thrust surface turns, and the composition may optionally pass through the applicator element.

The thrust surface may be covered at least in part by the coating. The device may include a blade defining the thrust surface, or indeed a plurality of blades.

The device may include a partition defining the backing surface, or as many partitions as there are respective blades. The coating may extend at least in part on the or each partition. At least one partition may include an orifice for homogenizing the composition and/or reducing pressure.

The second portion may co-operate with the first portion to define at least two chambers inside the container, so that turning the second portion causes the volume of one of the chambers to vary in one direction and the volume of the other chamber to vary in an opposite manner.

The applicator may be located substantially on the path of the composition flowing from the chamber of decreasing volume towards the chamber of increasing volume. The composition may pass through or around the applicator.

The second portion may also be formed by a piston that is movable in the first portion, e.g. under the effect of suction created in the container by a pump, or under the effect of a drive mechanism, e.g. a screw, or indeed under the effect of the applicator moving relative to the container.

The applicator may be secured to a cap for closing the container.

In an embodiment of the invention, the applicator may come close to the coating when it is engaged in the container. For example, the applicator may come into contact with the coating or may lie less than 1 mm therefrom when it is inside the container.

In an embodiment of the invention, the second portion may turn relative to the first, and the applicator may be carried by the second portion.

Thus, moving the second portion relative to the first can serve to drive the applicator so that it stirs the composition contained in the container. Under such circumstances, the applicator is advantageously off-center relative to the axis of rotation of the second portion, and preferably comes close to the coating.

The device may include a member that is moved by the applicator each time the applicator is inserted in or withdrawn from the container. By way of example, this member may be pierced by an opening of section smaller than the section of the applicator, so as to be moved by an applicator element of the applicator inside the container.

The composition may contain various ingredients conventionally encountered in cosmetics, in particular at least one: moisturizing; anti-wrinkle; soothing; thinning; anti-ring; anti-UV; or coloring agent, e.g. a pigment or a dye; or at least one oil or a solvent, in particular an organic solvent.

The composition may include an alcohol, in particular ethanol.

The invention also provides a method of fabricating a device as defined above, the device comprising:
a container comprising at least first and second portions, said portions being assembled to each other, the container defining an inside space containing the composition; and
a coating of material other than a plastics material, on a surface of at least one of the first and second portions, the coating coming into contact with the composition contained in the inside space of the container;

in which method the coating is deposited on at least one of the portions and then the two portions are assembled together. The coating may be deposited by a vacuum metal-plating technique. The coating need not be protected by any varnish once deposited on the container.

The coating may be deposited on a keying primary layer, where appropriate.

Independently or in combination with the above, the invention also provides a device for packaging a composition for application to keratinous materials, the device comprising:
a container comprising at least a first portion and a second portion, these portions being assembled together, the container defining an inside space containing the composition; and
a coating of a material other than a plastics material, e.g. a metal, in particular silver or copper, covering at least part of at least one of the first and second portions, the coating coming into contact with the composition contained in the container.

The invention according to another of its aspects, also provides a device for packaging a composition for application to keratinous materials, the device comprising:
a container comprising at least a first portion and a second portion being assembled together in a non detachable manner during the use of the device to apply the composition, and movable relative to each other and defining an inside space containing the composition,
a coating of a biocidal material covering at least part of at least one of the first and second portions and coming into contact with the composition contained in the inside space of the container.

After being assembled together the first portion and the second portion remain assembled in spite of their relative movements while the relative movements didn't take part to the assembly.

The invention according to another of its aspects, also provides a device for packaging a composition for application to keratinous materials, the device comprising:
a container comprising at least a first portion and a second portion assembled with the first portion defining an inside space containing the composition,
a coating of a biocidal material covering at least part of each of the first and second portions and coming into contact with the composition contained in the inside space of the container.

The invention according to another of its aspects, also provides a device for packaging a composition for application to keratinous materials, the device comprising:
a container defining an inside space containing the composition,
a coating of a biocidal material, preferably a metallic material, covering at least part of the container and coming into contact with the composition contained in the inside space of the container, this coating being deposited by a vacuum deposition technique or by an electrolytic deposition technique.

The invention also provides a container including a coating of a material other than a thermoplastic material, in particular a coating of a metal, e.g. silver or copper, and a member for stirring the composition inside the container, e.g. a member as defined above, such as a blade, a piston, a member moved by the applicator on being inserted or withdrawn, an applicator that is off-center and driven in rotation relative to the container, or a stirrer ball.

The invention can be better understood on reading the following detailed description of non-limiting embodiments thereof, and on examining the accompanying drawings, in which:

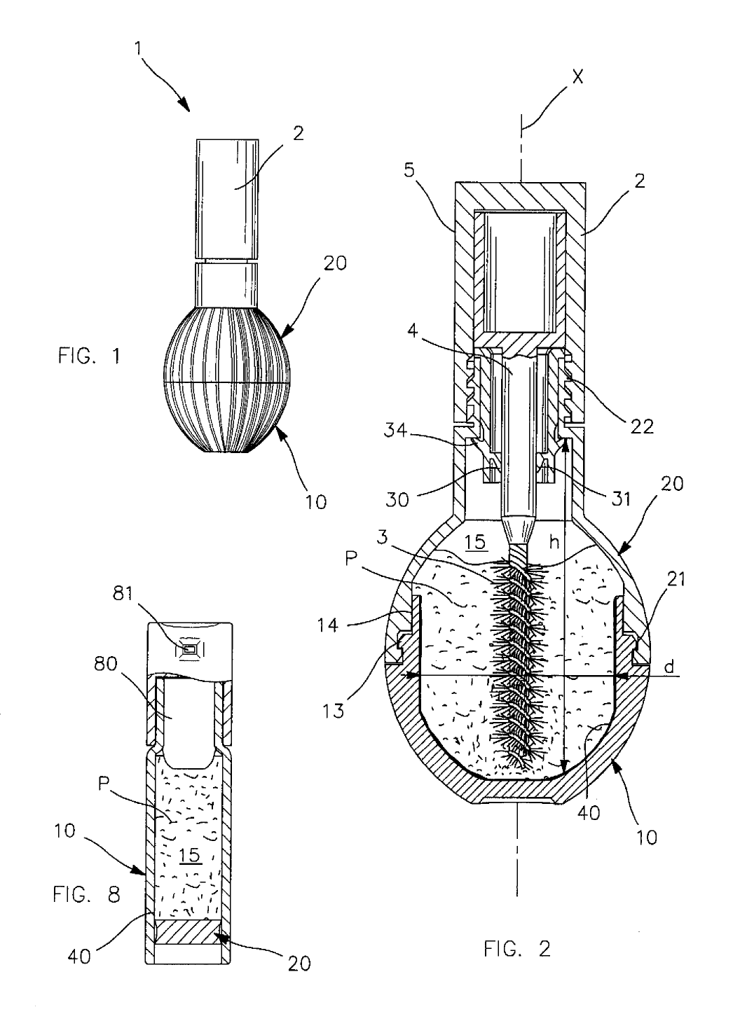

FIG. 1 is a diagrammatic elevation view showing an example of a device made in accordance with the invention;

FIG. 2 is a diagrammatic longitudinal section of the FIG. 1 device;

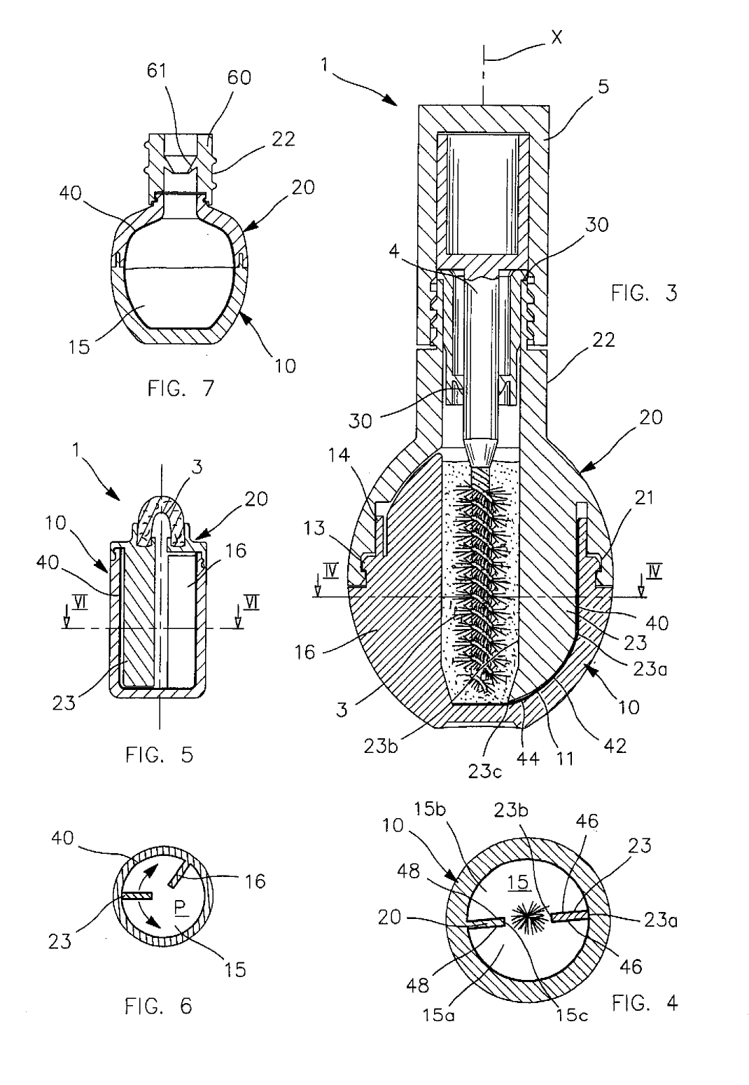

FIG. 3 is a view analogous to FIG. 2 showing a variant of the FIG. 1 device;

FIG. 4 is a cross-section on IV-IV of FIG. 3;

FIG. 5 is a longitudinal section of another variant embodiment of the device;

FIG. 6 is a cross-section on VI-VI of FIG. 5;

FIGS. 7 and 8 are diagrammatic and fragmentary longitudinal section views of devices constituting variant embodiments of the invention;

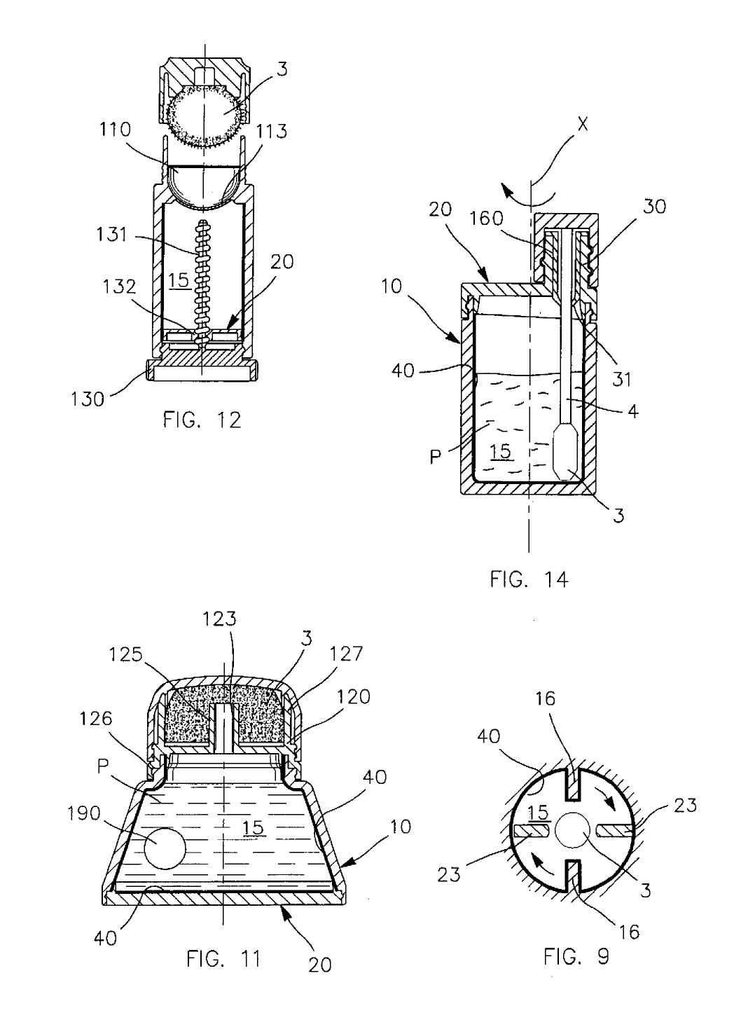

FIG. 9 is a view analogous to FIG. 4 showing a variant embodiment;

FIGS. 10 to 15 are fragmentary and diagrammatic longitudinal sections showing various devices of the invention;

FIGS. 16 to 23 are diagrammatic and fragmentary views of variant applicators; and

FIG. 24 is a diagrammatic and fragmentary perspective view of a variant embodiment of the device.

FIGS. 1 and 2 show a packaging and applicator device 1 made in accordance with the invention. The device 1 comprises a container having a first portion 10, and a second portion 20 that is assembled to the first. The device 1 also includes an applicator 2 having an applicator element 3, e.g. constituted by a mascara brush, as shown. The applicator 3 may be of any type, being selected as a function of the keratinous material to be treated.

In a variant not shown, the applicator 3 is thus a flocked endpiece and the composition may be for application to the skin or to the lips, for example.

The applicator element 3 is connected by a stem 4 to a handle member 5, which handle member also constitutes a cap for closing the container.

In the example shown, the stem 4 extends along an axis X that coincides with the longitudinal axis of the device, but that could be different without thereby going beyond the ambit of the present invention.

The first and second portions define an inside space 15 containing a composition P for application to keratinous materials.

The inside space 15 may present a ratio of greatest transverse dimension (d) divided by height (h) lying in the range 0.5 to 3, better in the range 0.75 to 1.5.

The depth of the inside space 15 is about 5 centimeters (cm) in one example, and its width is 3 cm. In another example, its width is 3 cm for a depth of 4 cm.

The first portion 10 includes a top portion 13 in relief with an annular sealing lip 14. The second portion 20 includes an outer skirt 21 arranged to snap onto the portion 13 in relief, said skirt 21 being made integrally in the example described with a threaded neck 22 for fastening the closure cap 5.

By way of example, the portion 13 in relief is made in the form of an annular bead that may be continuous or discontinuous, so as to prevent the first portion from moving axially relative to the second.

As can be seen in FIG. 2, the device 1 may include a wiper member 30 that is inserted in the neck 22 in order to wipe the applicator element 3 as it leaves the container.

The wiper member 30 may be of any type, and for example it may include a flexible lip 31 defining a circular wiper orifice at its bottom end, which orifice has a diameter that is substantially equal to the diameter of the stem 4.

The wiper member 30 need not be a fitting separate from the neck 22, it could be molded therewith or overmolded thereon.

As shown, the wiper member 30 may include retaining tabs 34 in the neck 22 that bear against a shoulder of the neck 22.

The first and second portions 10 and 20 may be made of a thermoplastic material, for example a polyolefin, e.g. polyethylene (PE) or polypropylene (PP), or out of other plastics materials, e.g. selected from: polyamide (PA); polyacetyl (POM); polystyrene (PS); acrylonitrile-butadiene-styrene copolymer (ABS); styrene acrylonitrile copolymer (SAN); or polyethylene terephthalate (PET); this list not being limiting. It can be advantageous to use different materials for making the first and second portions, in order to reduce friction between them.

In accordance with an aspect of the invention, at least one of the first and second portions 10 and 20 includes on its inside surface a coating 40 of a material that is designed to act on the composition, e.g. by progressively releasing at least one compound into it. The thickness of the coating 40 may lie in the range 10 μm to 20 μm, for example.

Making the container in two portions gives easy access to the inside surface of each of the two portions, e.g. for the purpose of metal-plating them, by using a vacuum evaporation technique or a cathode sputtering technique, for example.

By way of example, the coating 40 is a layer of silver deposited by such a technique on at least one of the two portions 10 and 20. Under the effect of oxidation while the device is in storage and in use, this layer of silver releases Ag⁺ ions that have a biocidal effect and that make it possible to reduce the content of preservatives in the composition when the container is filled. Where appropriate, the invention can make it possible to eliminate preservatives.

Inserting and removing the applicator element 3 in use serves to stir the composition to some extent within the container, thereby improving diffusion within the composition of the compound released by the coating 20, e.g. Ag⁺ ions.

In a variant, the applicator has a stem that is curved or that matches the shape of the wall of the container in such a manner that the relative movement of the stem inside the container, while being inserted therein or withdrawn therefrom, gives rise to better stirring of the composition within the container.

In such a variant in particular, the applicator element 3 of the applicator can optionally come into contact with the coating 40, being situated at a distance therefrom of at least 1 mm during storage, for example.

The device 1 can thus be made in accordance with the teaching of publication EP 1 584 260 A2, the first and second portions 10 and 20 then being movable and arranged in such a manner that turning one relative to the other serves to stir the composition to some extent.

By way of example, the second portion 20 may include a partition 23, as shown in FIGS. 3 and 4, which partition is made integrally with the outer skirt 21 and the neck 22.

The partition 23 may also be a separate fitting mounted on the second portion, thus making it easier for the partition 23 to be made of a different material, if so desired.

The partition 23 presents a shape that matches firstly the applicator element 3 and secondly the shape of the container 11 defined by the first portion 10.

In the example of FIG. 3, the partition 23 presents a radially outer edge 23a of profile enabling it to come close to the inside surface 42 of the container 11 so as to scrape the composition.

By way of example, the radially inner edge 23b of the partition 23 presents a bottom portion that is curved downwardly and inwardly so as to match substantially the shape of the applicator element 3.

The bottom edge 23c of the partition 23 substantially matches the shape of the bottom wall 44 of the container so as to scrape the composition that is present thereon.

The first portion includes a blade 16 extending in the inside space 15 radially towards its center, to come close to the applicator element 3, and substantially matching the shape thereof.

As can be seen in particular in FIGS. 3 and 4, the partition 23 and the blade 16 co-operate inside the space 15 to define two chambers 15a and 15b that communicate with each other via a central region 15c in which the applicator element 3 is situated when the applicator 2 is in place on the container.

Each main face of the blade 16 defines a rotary surface 48, one or other of which exerts thrust on the composition depending on the direction of rotation of the second portion 20. The partition 23 defines backing surfaces 46.

When the second portion 20 has finished turning relative to the first portion 10, one of the rotary surfaces 48 becomes substantially superposed on one of the backing surfaces 46.

When the user turns the second portion 20 relative to the first portion 10 in one direction or the other, the movement of the blade 16 inside the space 15 serves to reduce the volume of one of the chambers 15a or 15b while increasing the volume of the other chamber, thereby causing the composition to flow from one chamber to the other through the central region 15c, and the applicator element 3 can become loaded in composition.

When the second portion 20 is turned relative to the first portion 10, the movement of the blade 16 in the inside space 15 causes the composition P to be stirred to some extent, thereby contributing to homogenizing it and encouraging diffusion of the compound that is released into the composition by the coating 40, e.g. Ag⁺ ions.

In the variant shown in FIGS. 5 and 6, the packaging and applicator device includes an applicator member 3 that is permanently fastened on the container, e.g. on the second portion 20.

The applicator member 3 may then be in the form of an applicator endpiece, e.g. a foam, a flocked endpiece, a perforated plate, or a felt tip, this list not being limiting.

The first portion 10 includes a blade 16 as in the example of FIG. 3, and the second portion 20 includes a partition 23. Turning the first portion about the axis X relative to the second serves to stir the composition P contained in the inside space of the container so as to increase diffusion of the compound released by the coating 40 into the composition.

In the examples of FIGS. 3 to 6, the coating 40 may optionally extend over the partition 23 and the blade 16.

FIG. 7 shows the possibility of making the container with a neck 22 that is secured to an end portion 60 fitted on the second portion 20, the end portion 60 having a wiper lip 61 for wiping the applicator (not shown) while it is being extracted from the container.

In the example of FIG. 8, the container comprises a first portion 10 defining the inside space 15 containing the composition and a second portion 20 constituting the bottom of the inside space 15, and in the form of a piston that can be moved in leaktight manner along the inside surface of the first portion 10 as the composition is being dispensed. By way of example, the composition may be dispensed by means of a pump 80 carrying a dispenser endpiece 81, while fastened on the first portion 10.

As the composition P is being dispensed and the container is being emptied, the second portion 20 rises towards the pump 80 and scrapes against the inside surface of the first portion 10, thereby stirring the composition P to some extent within the container and making it easier for at least one compound coming from the coating 40 that covers the inside surface of the first portion 10 to pass into solution.

FIG. 9 shows a variant embodiment that differs from that shown in FIG. 4 by the fact that the second portion 20 has two partitions 23 that are diametrically opposite each other, and the first portion 10 includes two blades 16, likewise diametrically opposite each other. This serves to reduce the angular stroke of the second portion 20 relative to the first portion 10, while ensuring that the composition is stirred effectively within the container.

In the embodiment of FIG. 10, the container comprises a first portion in the form of a pot having a second portion 20 fitted onto the top thereof to define a housing 110 for receiving an applicator element 3 that is secured to a closure cap 111 for the container.

The bottom wall 113 of the housing 110 is perforated so as to enable the housing to be fed with composition P coming from the inside space 15 of the container.

In the example described, the coating 40 extends over the inside surface of the first portion 10.

By way of example, the applicator element 3 comes into contact with the wall 113 when the cap 111 closes the container in leaktight manner.

In the variant of FIG. 11, the applicator element 3 is permanently secured to the container, the container being made up by assembling together a first portion 10 defining the body of the container and a second portion 20 constituting the bottom of the container.

By way of example, the coating 40 that extends over the first portion 10 is made of a first material, and for example the second portion 20 carries another coating 40 made of a second material different from the first, the first material being silver and the second material being copper, for example.

The container in this example includes a support 120 that is fitted to the first portion 10, e.g. by snap-fastening, the support 120 carrying the applicator element 3 and enabling it to be fed with composition P coming from the inside space 15 of the container.

By way of example, the applicator element 3 is fed via a chimney 123 of the support 120.

By way of example, the applicator element is a porous applicator member, e.g. a foam, presenting a central opening 125 enabling it to be put into place on the chimney 123 and being partially received in an annular groove 126 formed between the chimney and an outer skirt 127 of the support 120.

A stirring ball 190 may be placed inside the container for stirring the composition.

The variant of FIG. 12 differs from that of FIG. 10 by the fact that the bottom of the container is defined by a piston that can rise in the first portion 10 under the effect of turning a drive knob 130 coupled to a screw 131, the piston being pierced by an opening 132 that engages the screw 131. The inside section of the container is not a surface of revolution in order to ensure that turning the screw 131 drives the piston 20 axially.

Furthermore, in this example, the composition is dispensed through at least one perforated wall 113 defining the bottom of a housing 110 that receives the applicator element 3, in a manner similar to the example of FIG. 10. The wall 113 is made integrally with the first portion 10, but it could be a separate fitting.

In the example of FIG. 13, a stirring member 150 is movable inside the container along its longitudinal axis, said member being moved by the applicator. The member 150 has a central passage 152 through which the applicator element 3 passes when the applicator is withdrawn or put into place in the container.

The central opening 152 presents an inside section that is slightly smaller than the outside section of the applicator element 3, such that while the applicator element is being extracted, the applicator element 3 catches temporarily on the member 150, pulling it upwards within the inside space 15 of the container. This upward movement serves to cause the composition to move in contact with the coating 40.

The upward movement of the member 150 can continue until it reaches the bottom of the neck 155 of the container, or in a variant it can take place over a shorter distance, depending for example on the speed with which the applicator is withdrawn and the friction forces between the member 150 and the inside wall of the container, the member 150 having an outside diameter that corresponds substantially to the inside diameter of the container, for example.

While the applicator is being put back into place in the container, the applicator element 3 passes through the central orifice 152 and pushes the member 150 downwards, thereby stirring the composition.

The coating 40 may extend over the entire inside surface of the container, or in a variant, it may extend over only a fraction thereof.

By way of example, the container is formed by assembling together a first portion 10 of elongate shape provided at its top end with a neck 155, and a second portion 20 that constitutes the bottom, as shown. Other ways of making the container are also possible, e.g. with a neck that is fitted thereto and a bottom that is integral with the body.

The member 150 may be made of any suitable material, for example it may be a washer of thermoplastic material, possibly coated in a material presenting biocidal or other properties. The member 150 may also be made of metal.

The member 150 may be put into place in the container prior to the second portion 20 being positioned.

The container may include a wiper member 30.

In the example of FIG. 14, the applicator is carried by the second portion 20 that is capable of turning about an axis of rotation X relative to the first portion 10. The first portion 10 constitutes a pot containing the composition P.

By way of example, the applicator is releasably fastened on the second portion 20, the second portion being made with a neck 160 on which the applicator can be fastened, for example.

The neck 160 may house a wiper member 30.

The applicator element 3 is off-center relative to the axis X, being close to the coating 40 covering the first portion 10.

Thus, when the second portion 20 is turned relative to the first, the applicator element 3 can stir the composition P close to the coating 40.

Where appropriate, the applicator element 3 can come into contact with the coating 40 when it is in place, with turning of the second portion 20 being accompanied by the applicator element rubbing against the coating 40.

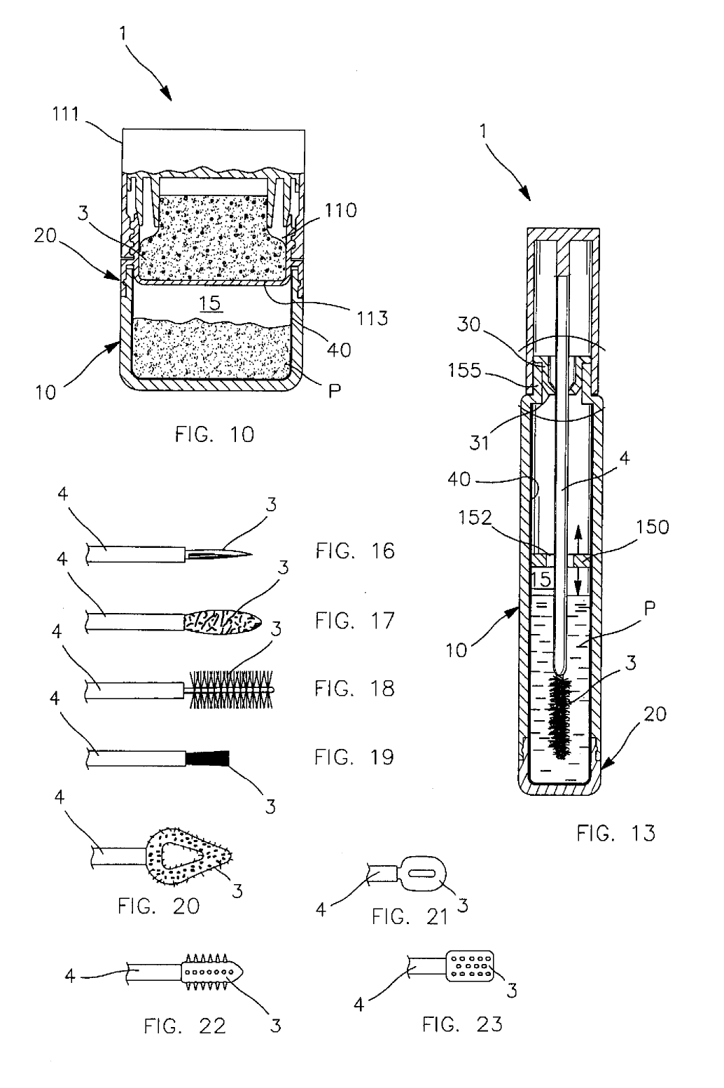

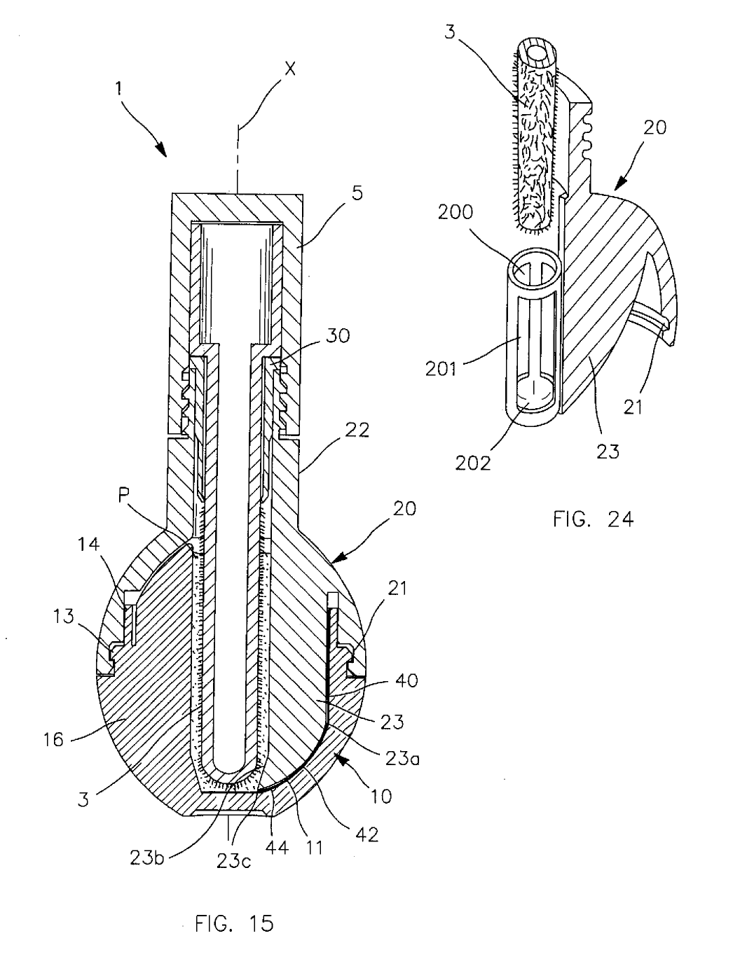

In the variant of FIG. 15, the mascara brush of the example of FIG. 3 is replaced by a flocked endpiece 3 that includes flocking that extends over the major fraction of the height of the inside space 15, by way of example.

The device may include a wiper member 30 for wiping the endpiece while it is being withdrawn from the container.

By way of example, the endpiece is made to be tubular in shape, being closed at its distal end. In a variant, the endpiece is solid.

In the example shown, the blade 16 turns directly around the endpiece.

Where appropriate, the housing of the container receiving the endpiece may be formed at least in part by a perforated chimney 200, as shown in FIG. 24.

The chimney 200 in which the applicator can be inserted can be fastened to the partition 23, e.g. being molded integrally therewith, and the blade 16 can turn around the chimney 200.

The size of the perforations 201 in the chimney 200 can be relatively large, for example the perforations may occupy more than half of the periphery of the chimney.

The bottom 202 of the chimney may be closed, in order to avoid excess composition accumulating at the distal end of the endpiece 3. The endpiece may come close to or may bear against the bottom of the chimney when it is in place on the container.

The material of the endpiece may be rigid or flexible, and it may optionally have a chamfered end for application on the lips.

The invention is not limited to particular applicator elements.

At least in all of the examples where the applicator element is inserted in the container and is withdrawn for application purposes, in particular those shown in FIGS. 2, 3, 4, 13, and 14, the applicator element may be a felt tip as shown in FIG. 16, a foam as shown in FIG. 17, a brush with a twisted core as shown in FIG. 18, a paint brush as shown in FIG. 19, a flocked endpiece, optionally perforated, as shown in FIG. 20, a paddle with one or more perforations as shown in FIGS. 21 and 23, an injected comb or brush as shown in FIG. 22, this list not being limiting, it also being possible for the applicator element to be a sintered piece, or a flocked foam, or a membrane.

Naturally, the invention is not restricted to the examples shown.

By way of example, the invention can be applied to any of the embodiments shown in EP 1 584 260 A2.

The term “comprising a” should be understood as being synonymous with “comprising at least one”.

1. A device for packaging a composition for applying to keratinous materials, the device comprising:
a container defining an inside space containing the composition;
a coating of a biocidal material covering at least part of the container and coming into contact with the composition contained in the inside space of the container;
a member that is movable within the container

2. A device according to claim 1, the movable member coming near the coating or even in contact with the coating.

3. A device according to claim 2, the distance between the movable member and the coating being in the range 0 to 3 mm.

4. A device according to claim 2, wherein the movable member is capable of stirring the composition along a lateral inside wall of the container in a manner so as to force the composition to flow along this inside wall on which the coating is disposed.

5. A device according to claim 4, wherein after having flowed along the lateral inner wall of the container, the composition is directed by the movable member towards an applicator.

6. A device according to claim 5, wherein the movable member is made by at least a first blade which cooperates with at least a second blade mobile in relation to the first blade, to define two chambers inside the container and at least a passage between both chambers disposed between the first and second blades,
and wherein the applicator is disposed at least in part in this passage, a movement of the first blade in relation to the second blade causing volume variations of the chambers and causing emptying of one of the chambers towards the other chamber through the passage.

7. A device according to claim 6, wherein the passage is made by an interstice between the first blade and the second blade, this interstice being opened from the bottom to the top of the blades or on part of the height of the blades partially joined.

8. A device according to claim 2, wherein the movable member inside the container comes in contact with the coating and rub on the coating.

9. A device according to claim 1, comprising a closure cap for closing the container.

10. A device according to claim 1, the coating comprising at least one metal compound.

11. A device according to claim 10, the metal compound comprising silver and/or copper.

12. A device according to claim 1, the container being made of metal, glass, or a plastics material.

13. A device according to claim 1, the inside space presenting a ratio of its greatest transverse dimension divided by its height lying in the range 0.5 to 3.

14. A device according to claim 1, the container being deeper than it is wide.

15. A device according to claim 1, comprising at least one applicator.

16. A device according to claim 9, the applicator being secured to a closure cap.

17. A device according to claim 1, the applicator coming close to the coating on being engaged in the container.

18. A device according to claim 17, the applicator coming into contact with the coating or to within at least 1 mm therefrom when it is inside the container.

19. A device according to claim 1, the container comprising at least a first portion and a second portion.

20. A device according to claim 19, the coating extending over both the first and the second portions.

21. A device according to claim 19, the first and second portions being stationary relative to each other.

22. A device according to claim 19, the first and second portions being movable relative to each other.

23. A device according to claim 22, the first portion defining at least one thrust surface in contact with the composition inside the container, the applicator and said thrust surface being arranged in such a manner that turning said surface exerts pressure on the composition causing the composition to move inside the container, the second portion defining at least one backing surface against which said thrust surface can come at least partially opposite to the end of turning the first portion.

24. A device according to claim 23, the thrust surface being covered in at least in part by the coating.

25. A device according to claim 23, comprising a blade defining the thrust surface.

26. A device according to claim 23, comprising a partition defining the backing surface.

27. A device according to claim 26, the coating extending at least in part on the partition.

28. A device according to claim 23, the device comprising an applicator comprising an applicator member received inside the container in a space around which said thrust surface turns.

29. A device according to claim 19, the second portion co-operating with the first portion to define at least two chambers inside the container, turning the second portion causing the volume of one of the chambers to vary and causing inverse variation in the volume of the other chamber.

30. A device according to to claim 29, the device comprising an applicator being disposed substantially on the path of the composition flowing from the chamber of volume that is decreasing towards the chamber of volume that is increasing.

31. A device according to claim 1, the coating being deposited by a vacuum deposition technique.

32. A device according to claim 1, comprising means enabling the composition to be moved in contact with the coating.

33. A device according to claim 19, the second portion being formed by a piston that is movable in the first portion.

34. A device according to claim 19, the second portion and the first portion bearing against each other in leaktight manner.

35. A device according to to claim 19, the device comprising an applicator, the second portion being capable of turning relative to the first and the applicator being carried by the second portion.

36. A device according to claim 15, comprising a member configured to be moved by the applicator on being inserted in and/or withdrawn from the container.

37. A device according to claim 36, the member being pierced by an opening of section smaller than the section of the applicator.

38. A device according to claim 36, comprising stirrer ball in the container.

39. A device according to claim 1, the coating being deposited by an electrolytic deposition technique.

40. A device according to claim 19, the material constituting the coating being suitable for dispersing under the effect of the second portion moving relative to the first.

41. A device according to claim 1, the container comprising a wall coated with the coating, the ratio of the thickness of the wall divided by the thickness of the coating being greater than or equal to 100.

42. A device according to claim 26, comprising a perforated chimney in which the applicator can be inserted, the chimney being fastened to the partition.

43. A device according to claim 8, said member being an applicator or a movable portion constitutive of the container, i.e. a movable piston.

44. A method of fabricating a device as defined as in claim 1, the device comprising:
a container comprising at least first and second portions, said portions being assembled to each other, the container defining an inside space containing the composition; and
a coating of biocidal material on a surface of at least one of the first and second portions, the coating coming into contact with the composition contained in the inside space of the container;
in which method the coating is deposited by a vacuum deposition technique or by an electrolytic deposition technique on at least one of the portions and then the two portions are assembled together.

45. A method according to claim 44, the coating being deposited by a vacuum deposition technique.

46. A method according to claim 4, the coating being deposited on a keying primary layer.
